(19) United States
(12) Patent Application Publication
(10) Pub. No.: US 2022/0198863 A1
(43) Pub. Date: Jun. 23, 2022

(54) AUTHENTICATION INPUT DEVICE

(71) Applicant: IGLOOCOMPANY PTE. LTD., Singapore (SG)

(72) Inventors: Khee Kien HO, Singapore (SG); Anthony CHOW WEN JIE, Singapore (SG)

(73) Assignee: IGLOOCOMPANY PTE. LTD., Singapore (SG)

(21) Appl. No.: 17/615,284

(22) PCT Filed: May 28, 2020
(86) PCT No.: PCT/SG2020/050315

§ 371 Date: Nov. 30, 2021

(30) Foreign Application Priority Data
May 31, 2019 (SG) 10201905015W

(51) Int. Cl. G07C 9/33; G07C 9/00

(52) U.S. Cl. CPC G07C 9/33; G07C 9/00571; G07C 9/00563

(57) ABSTRACT

An electronic lock comprising a housing, a keypad carried by the housing and a plurality of authentication input devices on the keypad configured for sensing a user's finger, each of the plurality of authentication input devices including a key sensor associated with an alphanumeric character and a finger sensor configured to acquire fingerprint biometric data, wherein, by a single act of pressing the plurality of authentication input devices by the user, authenticates input of a password and fingerprint biometric data for activating release of the electronic lock to an open position for access by the user in response to the password matching the predetermined password and the fingerprint biometric data acquired by at least one of the finger sensors matching the predetermined fingerprint matching data.

### TECHNICAL FIELD

The present disclosure generally relates to authentication input devices. More particularly, the present disclosure relates to real-time authentication input devices for use in electronic locks.

### BACKGROUND

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

Conventionally, electronic locking devices include the use of a password and/or biometric data from an authorized user or an individual to unlock the lock. To increase the security of the area or property that is accessed by an entry that is installed with an electronic locking device, electronic locking devices typically use a password and biometric data to manage access to the area or property. A password can be in the form of alphanumeric characters, for example, numbers or letters or a combination of both letters and numbers. Biometric data relates to any metrics related to an individual's features. Fingerprint technology is one of the methods used for unlocking electronic locks.

Some buildings or properties may have units installed with electronic locking devices that are configured for connection to and controlled by an access management system. The access management system provides administrator controls of each individual electronic locking device and can grant access to authorized individuals or users by issuing the residents of a unit a shared passcode. The authorized user or the residents of the unit will then key in the passcode, for example, a series of numbers, into the electronic locking device in order to access the unit. For electronic locking devices that are not managed by an access management system, a password or security code is pre-configured and issued by the owner or administrator of the electronic locking device to authorized users. Any one of the authorized users will then key in the passcode into the electronic locking device.

For electronic locking devices that utilize fingerprint sensing technology, the next step of authentication uses fingerprint information from the authorized user to unlock the electronic locking device and to grant access to the authorized user. Each of the authorized users or residents of a unit will have their biometric signatures or fingerprints pre-registered and saved on the electronic locking device so that when any one of the authorized user places his or her finger on the fingerprint sensor, the electronic locking device will be able to match the fingerprint information with the pre-registered fingerprint information and provide access to the authorized user when the fingerprint information matches.

While the above steps of authentication may provide increased security to the property, the electronic locking device may take an inordinate length of time to authenticate and grant access to the authorized user. Accordingly, it would be desirable to provide an electronic locking device that provides a quicker and more efficient authentication.

Electronic devices or electronic locking devices that make use of a single mode of authentication, for example, by keying in a passcode on a touch sensor display or virtual keypad, may also be susceptible to unauthorized sharing or leaked personal identification numbers (PIN), that may result in security breaches. On electronic devices such as mobile smartphones or portable laptops, security breaches could lead to stolen data or loss of confidential information or trade secrets. Accordingly, it would be desirable to provide an authentication input device that could be installed on such electronic devices or electronic locking devices to provide enhanced security.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the invention, there is disclosed an electronic lock comprising a housing, a keypad carried by the housing, a plurality of authentication input devices on the keypad configured for sensing a user's finger, each of the plurality of authentication input devices including a key sensor associated with an alphanumeric character and a finger sensor configured to acquire fingerprint biometric data. The electronic lock further includes an authentication module configured to authenticate a user based on a password entered into the key sensors, the password comprising a sequence of alphanumeric characters acquired by the key sensors that matches with a predetermined password stored in a password database, and the fingerprint biometric data acquired by the finger sensors that matches a predetermined fingerprint matching data stored in a fingerprint database, wherein, by a single act of pressing the plurality of authentication input devices by the user, the authentication modules authenticates the password and the fingerprint biometric data for activating release of the electronic lock to an open position for access by the user in response to the password matching the predetermined password and the fingerprint biometric data acquired by at least one of the finger sensors matching the predetermined fingerprint matching data.

Preferably, the fingerprint matching data includes fingerprint biometric data of a plurality of fingers obtained from the user.

Preferably, each of the plurality of authentication input devices is configured for display on the keypad and associated with an alphanumeric character representing a different number or character.

Preferably, each of the plurality of authentication input devices on the keypad is a graphical button represented on a capacitive touchscreen.

Preferably, each of the plurality of authentication input devices on the keypad is a pushbutton.

Preferably, a wireless transceiver in wireless communication with a user device in communication with an access management application can synchronize the predetermined passwords stored in the password database and the fingerprint matching data stored in the fingerprint database to a password and fingerprint database stored on a remote server in wireless communication with the access management application.

Preferably, the electronic lock further comprises a wireless transceiver in wireless communication with a user device in communication with an access management application for configuration of the predetermined password and acquisition of fingerprint matching data.

Preferably, the keypad is a touchscreen.

Preferably, the keypad is a physical keypad.

Preferably, each of the key sensors corresponding to each of the plurality of authentication input devices receives a signal input associated with the alphanumeric character that the key sensor is assigned to in response to sensing the user's finger.

In accordance with a second aspect of the invention, there is disclosed a method for controlling access to an entry point secured by an electronic lock controlled by a lock controller having a memory, the method comprising the steps of: acquiring a sequence of alphanumeric characters defining a password from a plurality of authentication input devices on a keypad, wherein each of the plurality of authentication input devices includes a key sensor configured to sense the user's finger; acquiring fingerprint biometric data of the user's finger from the plurality of authentication input devices at the same time the sequence of alphanumeric characters defining the password is acquired, wherein each of the plurality of authentication input devices includes a fingerprint sensor configured to acquire fingerprint biometric data; authenticating the user, by an authentication module cooperating with the lock controller, based upon a first match between the password and a predetermined password stored in a password database, and a second match between the acquired fingerprint biometric data and a fingerprint matching data stored in a fingerprint database; and releasing, by the lock controller, of the electronic lock into an open position for granting access to the entry point to the user, in response to a successful authentication of the first match and the second match.

Preferably, the second match is defined by the fingerprint biometric data acquired by at least one of the fingerprint sensors matching the fingerprint matching data stored in the fingerprint database.

Preferably, the second match is defined by the fingerprint biometric data acquired by all the fingerprint sensors matching the fingerprint matching data stored in the fingerprint database.

Preferably, the fingerprint matching data stored in the fingerprint database includes fingerprint data of a plurality of fingers of the user obtained from the user.

Preferably, each of the plurality of authentication input devices is configured for display on the keypad and associated with an alphanumeric character representing a different number or character.

Preferably, each of the plurality of authentication input devices on the keypad is a graphical button represented on a capacitive touchscreen.

Preferably, each of the plurality of authentication input devices on the keypad is a pushbutton.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. The dimensions of the various features or elements may be arbitrarily expanded or reduced for clarity. In the following description, various embodiments of the invention are described with reference to the following drawings, in which:

FIG. 1 shows a high-level block diagram of an electronic lock according to various embodiments;

FIG. 2 shows an exemplary embodiment of the electronic lock according to various embodiments;

FIG. 3 illustrates a high-level overview of the internal components of the electronic lock interacting with other components according to various embodiments; and

FIG. 4 illustrates a block diagram of an authentication input device according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

In order that the invention may be readily understood and put into practical effect, particular embodiments will now be described by way of examples and not limitations, and with reference to the figures. It will be understood that any property described herein for a specific system may also hold for any system described herein. It will be understood that any property described herein for a specific method may also hold for any method described herein. Furthermore, it will be understood that for any system or method described herein, not necessarily all the components or steps described must be enclosed in the system or method, but only some (but not all) components or steps may be enclosed.

The term “coupled” (or “connected”) herein may be understood as electrically coupled or as mechanically coupled, for example attached or fixed, or just in contact without any fixation, and it will be understood that both direct coupling or indirect coupling (in other words: coupling without direct contact) may be provided.

To achieve the stated features, advantages and objects, the present disclosure provides solutions that make use of computer hardware and software to improve the security and efficiency of authentication of an electronic locking device. The present disclosure can be applied to an electronic locking device with no capability of connection to a network or to a remote access management system or to an electronic locking device that is configurable for access to a network or to a remote access management system.

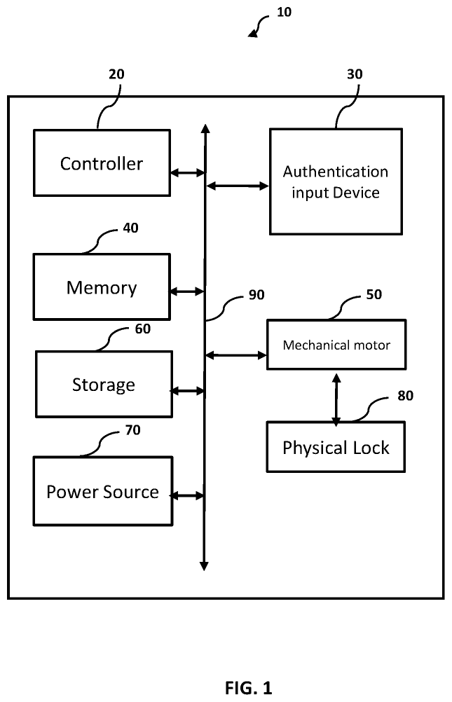

FIG. 1 illustrates a high-level block diagram of the internal electronics of an electronic lock 10, according to various embodiments. The embodiment of FIG. 1 includes an electronic lock 10 that comprises a controller 20 that operably communicates with a memory 40, a storage 60, a password interface module, and a power source 70 over a bus 90. The bus 90 may include any number of technologies, including industry standard architecture (ISA), extended ISA (EISA), peripheral component interconnect (PCI), peripheral component interconnect extended (PCIx), PCI express (PCIe), or any number of other technologies.

In some embodiments, the electronic lock further includes a wireless transceiver (not shown) for wireless communication with a remote access management system or an application server through a network. In some embodiments, the wireless transceiver can communicate wirelessly with a user device or through the remote access management system via the network. Such electronic locks may be referred to as ‘smart locks’ and may rely on a single factor or multi-factor authentication methods for unlocking the electronic locking device. Where increased security is desired, multi-factor authentication is used. A multi-factor authentication is based on two or more factors, and these factors are based on what the user knows and who the user is. For example, factors that are based on what the user knows may include a pre-configured password issued by the owner or administrator, or a server-generated password or a one-time password. Factors that are based on who the user is include biometric information including facial recognition or fingerprint information. While the present disclosure may apply to electronic locks utilizing multifactor authentication, the electronic locks include those with no access to a remote access management system and those with access to a remote access management system.

In various embodiments, the wireless transceiver can communicate via any of various technologies, such as a cellular network, a short-range wireless network, a wireless local area network (WLAN), etc. The cellular network can be any of various types, such as code division multiple access (CDMA), time division multiple access (TDMA), global system for mobile communication (GSM), long term evolution (LTE), 3G, 4G, 5G, etc. The short-range wireless network can also be any of various types, such as Bluetooth, Bluetooth Low Energy (BLE), near field communication (NFC), NB-IoT, etc.

The electronic lock also includes the standard structure of conventional door locks with moving parts to lock or to unlock the door. The electronic lock can be installed on any door that provides access to a building, residential unit, room, hotel room, car, safe, cabinet, or the like. The controller 20 controls a mechanical motor 50 which causes the mechanical motor 50 to open or close the physical lock 80. The mechanical motor 50 can have the associated gears in order to generate the torque required to move the physical lock 80. The physical lock 80 may take many form factors including padlocks, deadbolts, mortises, rim locks, latches and electro-magnetic door locks. The controller 20 includes a memory 40 that stores digital keys, biometric data, access details, logs of user interactions or associated timestamps and a record of the owner or administrator data. The memory 40 may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magneto resistive Random Access Memory) or a PCRAM (Phase Change Random Access Memory).

As used herein, the term ‘controller’ broadly refers to and is not limited to single or multi-core general purpose processor, a special purpose processor, a conventional processor, a graphical processing unit, a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit, a system on a chip (SOC), and/or a state machine.

The electronic lock includes a power source 70 that provides power supply to the electronic lock. The power source can be a battery energy source, for example, a rechargeable battery.

In some embodiments, the electronic lock 10 is pre-configured by the owner or administrator to generate a password to one or more authorized users. The issued password may be a shared password for all authorized users or different passcodes for individual authorized users. Each of the authorized users will also have their biometric data stored into the memory 40. For example, the biometric data can include one or more fingerprint image of at least a portion of one or more of the user's fingers of the authorized user for granting access. This can be done by a user scanning a finger on a fingerprint sensor or on the password interface module to obtain a fingerprint image of at least a portion of one or more of the user's fingers.

When the authorized user wishes to gain access to a door, the user keys in the password into an authentication input device 30 of the electronic lock. The authentication input device 30 may comprise an input device for receiving an input from a user and a fingerprint sensor for receiving and sensing biometric data from a user. In this way, the authentication input device 30 utilizes two modes of authentication: the first mode requires the use of a passcode and the second mode requires the use of fingerprint information of the authorized user to unlock the device. By using the authentication input device 30, the authorized user only has to key in the password once for the electronic lock to unlock since the authentication input device 30 also receives the fingerprint information of the user at the same time the password is keyed in.

The password may be a string of characters, such as alphanumeric characters. As the user is keying in each character of the password into the authentication input device 30, the authentication input device 30 will, at the same time, receive the fingerprint image of at least a portion of one of the user's fingers. The authentication input device 30 will receive both the password and the fingerprint information and send them to the controller 20. The controller 20 compares both the password and the fingerprint information to the fingerprint information database and passwords stored in the memory of the electronic lock 10. Once the password and the fingerprint information matches, the controller 20 will deem the data to be valid and the controller 20 will send a signal to cause the mechanical motor 50 to actuate the physical lock 80 to grant access to the authorized user. In other words, the authorized user only has to input the password which simultaneously also authenticates the fingerprint image of the authorized user who has keyed in the password, resulting in in a quicker and more efficient authentication, saving the authorized user time to gain entry. In this way, the two modes of authentication can be done in one step or in real-time or ‘on-the-fly’ while the user is keying in the password on the authentication input device.

In another embodiment, in the case of an electronic lock capable of connecting to an access management system through a network, when the authorized user keys in a server-generated password or a server-generated one-time password on the password interface module, the controller 20 sends the password and fingerprint information to the access management system through a wireless transceiver in the electronic lock. The password and the fingerprint information are then compared to the fingerprint information database and passcodes stored remotely in the database of the access management system. Once the password and the fingerprint information matches, the access management system will deem the data to be valid and instructs the controller of the electronic locking device to send a signal to cause the mechanical motor to actuate the physical lock to grant access to the authorized user.

While the above embodiments relate to use of the authentication input device 30 on electronic locks, the authentication input device 30 can also be used on any electronic device or computing device that requires two or more modes of authentication. Electronic devices may include a personal computer, a portable computing device such as a laptop, computer monitor, a television, a mobile phone, or any other appropriate storage and/or communication device with input device capabilities. Generally, electronic devices include a processor, memory, an input device and an output device. Some electronic devices typically require passcode authentication to restrict access to the content of the electronic devices. For example, electronic devices such as laptops, mobile smartphones, mobile tablets, typically require a single mode of authentication. The single mode of authentication may be a password or a form of biometric authentication. Such electronic devices can benefit from the authentication input device of the present disclosure. When the authorized user wishes to gain access to an electronic device, the user keys in the password into an authentication input device of the electronic device. The authentication input device 30 may comprise an input device for receiving an input from a user and a fingerprint sensor for receiving and sensing biometric data from a user. In this way, the authentication input device 30 utilizes two modes of authentication: the first mode requires the use of a password and the second mode requires the use of fingerprint information of the authorized user to unlock the electronic device. By using the authentication input device, the authorized user only has to key in the password once for the electronic device to unlock since the authentication input device 30 also receives the fingerprint information of the user at the same time the password is keyed in.

The authentication input device 30 can be any one of various input devices that enables a user to communicate information to the electronic lock or electronic device. The authentication input device 30 may be a touchscreen, a keypad or a touchpad suitable for entering a password. In some embodiments, the authentication input device 30 is a virtual keypad displayed by a touchscreen display. In some embodiments, the authentication input device 30 includes a capacitive sensor to detect a touch of a button of the keypad. In some embodiments, the authentication input device 30 is a force sensor to detect a touch of the button of the keypad. In some embodiments, the authentication input device is a mechanical keypad that includes physical buttons.

The authentication input device 30 also includes a fingerprint sensor. A fingerprint sensor generally refers to a device that retrieves fingerprint information. For example, a fingerprint sensor can include a device that retrieves fingerprint information, determines if that fingerprint information matches a known fingerprint, and allows access to functions of a device based on whether a match is found. Fingerprint information refers to one or more images of a user's finger or fingers, one or more images of a portion or portions of a user's finger or data relating to one or more fingerprints or portion of fingerprint, and compares with fingerprint information maintained in the memory or storage of the electronic locking device or a remote server. In some embodiments, the fingerprint sensor is integrated with the authentication input device. In some embodiments, the fingerprint sensor is positioned below the authentication input device and relatively centered with respect to the authentication input device or keypad or each character of virtual keypad. Although it does not have to be relatively centered with respect to each of the keys of the keypad, it is easier to obtain fingerprint information when the fingerprint sensor is centered and a user's fingers touches the center of the input device or keypad or each character of virtual keypad.

The fingerprint sensor can include a capacitive fingerprint sensor which a user can apply a portion of his finger to input fingerprint information. However, the fingerprint sensor is not limited to a capacitive fingerprint sensor. Any suitable fingerprint sensor may be used with embodiments or techniques disclosed herein. Other suitable fingerprint sensors may include capacitive sensors, ultrasonic sensors, optical sensors, pyro-electric sensors, or the like. The fingerprint sensor is operably connected to the controller of the electronic locking device, which maintains a fingerprint information database in the memory or storage or a remote access server, and which matches the fingerprint information obtained from users against the fingerprint information database. If the controller matches the fingerprint information against known fingerprint information of the authorized user, the controller will proceed to authorize the user by unlocking the electronic locking device or electronic device. If the fingerprint information against known fingerprint information of the authorized user is not matched, the controller will deny entry to the user and the electronic locking device or electronic device will remain unlocked.

As described above, the authentication input device is configured to provide two modes of authentication through a single mode of authentication, thereby providing real-time authentication or authentication ‘on-the-fly’ via a single step from the authorized user. In other embodiments, the authentication input device can be configured to allow the owner or administrator to choose a single mode of authentication while disabling the other mode of authentication. For example, if the authentication input device provides for a password and fingerprint information as the first and second mode of authentication respectively, the owner or administrator may choose to disable either the first mode (password) or the second mode (fingerprint information) and to use only a single mode of authentication. This can be provided as part of the user configuration or setting.

In other embodiments, the authentication input device may include a keypad or a virtual keypad that displays all the digits and/or alphanumeric characters on the keypad. As described above, the keypad or virtual keypad may include a touchscreen display or capacitive sensor to detect a touch of a button of the keypad. In some embodiments, the fingerprint sensor is present on each of all the available digits and/or alphanumeric characters, i.e. each available digit and/or alphanumeric character has a fingerprint sensor present. In this way, as the user is keying in each digit or alphanumeric character of the password into the authentication input device, the authentication input device will, at the same time, receive multiple fingerprint images of at least a portion of one of the user's fingers as he is keying in the password. The authentication input device will receive both the password and the plurality of fingerprint images and send them to the controller. The controller compares both the password and the plurality of fingerprint images to the fingerprint information database and passwords stored in the memory or the server. The controller can also compare the plurality of fingerprint images to the fingerprint information database to determine if the plurality of fingerprint images belong to the same person and not to more than one person.

In another embodiment, the authentication input device may include an ‘unlock’ key. The ‘unlock’ key may be present on a keypad or virtual keypad as a separate key from the digits or alphanumeric characters. Once the user keys in the password or PIN, the ‘unlock’ key is the final button to depress in order for the controller to receive the password or PIN. In some embodiments, the ‘unlock’ key may include a fingerprint sensor. In this way, the authentication input device will, at the same time the user presses the ‘unlock’ key, the fingerprint image of at least a portion of one of the user's fingers will be captured. The authentication input device will receive both the password and the fingerprint image and send them to the controller. The controller compares both the password and the fingerprint image to the fingerprint information database and passwords stored in the memory or the server.

As used herein, the term ‘network’ refers to a Local Area Network (LAN), a Metropolitan Area Network (MAN), a Wide Area Network (WAN), a proprietary network, and/or Internet Protocol (IP) network such as the Internet, an Intranet or an extranet. Each device, module or component within the system may be connected over a network or may be directly connected. A person skilled in the art will recognize that the terms ‘network’, ‘computer network’ and ‘online’ may be used interchangeably and do not imply a particular network embodiment. In general, any type of network may be used to implement the online or computer networked embodiment of the present invention. The network may be maintained by a server or a combination of servers or the network may be serverless. Additionally, any type of protocol (for example, HTTP, FTP, ICMP, UDP, WAP, SIP, H.323, NDMP, TCP/IP) may be used to communicate across the network. The devices as described herein may communicate via one or more such communication networks.

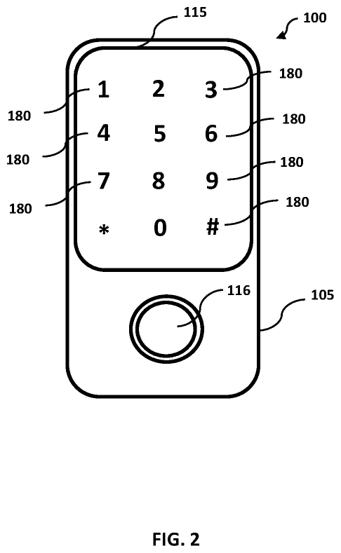

FIG. 2 illustrates an exemplary embodiment of an electronic lock 100 configured for mounting on lock stile (not shown) of a door above a door handle (not shown). A latch bolt (not shown) is operably connected to the door handle for securing the door to a strike (not shown), on an adjacent door jamb (not shown). In some embodiments, the adjacent door jamb may be an adjacent door. In some embodiments, the door lock and the door handle may be connected in one housing.

The electronic lock 100 includes a door lock housing 105, a keypad 115, and a key entry slot 116 operably connected to a deadbolt (not shown) for securing the door to a strike (not shown), on the adjacent door jamb. The keypad 115 in the electronic lock 100 is a numeric keypad displaying numbers zero through nine on ten keys in the layout illustrated in FIG. 1. The keypad 115 includes a plurality of authentication input devices 180. Each of the authentication input devices 180 includes a fingerprint sensor and a key sensor. Each alphanumeric character on the keypad 115 represented on each authentication input device 180 is indicative of a number or character. In this way, a user that is keying in a password or a Personal Identifier Number (PIN) such as a secret number or password into each key sensor will at the same time have the fingerprint sensor acquire fingerprint data from the user's finger as the user is keying in the numerical sequence of the passcode. In other words, with a single act of pressing the numerical sequence of the passcode on the authentication input device 180, the fingerprint sensor 190 acquires fingerprint data from the user's finger. Both the acquired numerical sequence denoting the passcode and the fingerprint data are then matched with a corresponding predetermined passcode and predetermined fingerprint matching data stored in a database. In some embodiments, the keypad includes a combination of input key sensors and authentication input devices. For example, in some embodiments, of the 12 alphanumeric characters of the keypad 115, all except one of the 12 alphanumeric characters are input key sensors and the remaining one may be an authentication input device comprising a fingerprint sensor and a key sensor combination.

The application is not intended to be limited to electronic lock including a keypad display, but can be applied to other home automation appliances or electronic devices with similar characteristics. In some embodiments, where the keypad is on an electronic lock, a home security system, a remote control, a telephone controller, or any home automation device with a keypad, additional keys may be present. In some embodiments, keys other than numeric keys on a keypad may be present. For example, the keypad may include other keys to the right and/or left of the“0” key such as a check mark, an “X”, and “*”, and/or “#” that may be illuminated to indicate the status of the electronic lock. In some embodiments, the non-numeric key may be an authentication input device comprising a fingerprint sensor and a key sensor combination.

In some embodiments, the keys may be a type of physical button, such as a physical momentary or push button, or a graphical button representation such as that presented on a resistive or capacitive touchscreen, or a combination thereof. In some embodiments, the keys have a light source (not shown) for illuminating the keys. In some embodiments, the light source may be capable of displaying varying degrees of luminous intensity and/or different colours.

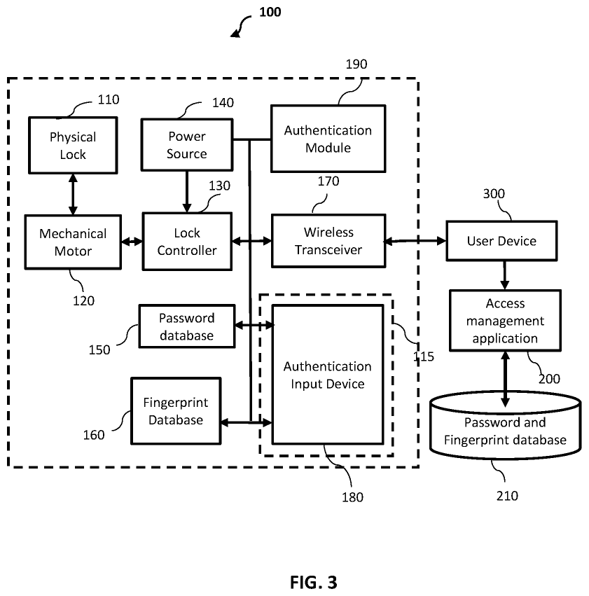

FIG. 3 illustrates a high-level block diagram showing the internal components of the electronic lock 100 configured for wireless communication with a user device 300 in data communication with an access management application 200 according to various embodiments. The electronic lock 100 is installed on an entry point of an object, property or key installation. The entry point may include a door, such as a door of a building, a door in a residential or commercial unit, a door of a cabinet, a door of a safe, a door of a vehicle, door of a container, door of a key installation, etc. The electronic lock 100 comprises a lock controller 130 in data communication with a memory (not shown) and a wireless transceiver 170, a power source 140 and a mechanical motor 120 coupled to a physical lock 110.

The electronic lock 100 includes a wireless transceiver 170 for wireless communication with the user device 300 through a network (not shown). The wireless transceiver 170 is in data communication with the lock controller and cooperates with the lock controller to perform at least one wireless communication function, for example, transfer of data. In some embodiments, the wireless transceiver 170 can transfer data wirelessly with the user device 300 via the network. In various embodiments, the wireless transceiver 170 can communicate via any of various technologies already mentioned above, such as a cellular network, a short-range wireless network, a wireless local area network (WLAN), a low-power Wide Area Network (LP-WAN), etc. The cellular network can be any of various types, such as code division multiple access (CDMA), time division multiple access (TDMA), global system for mobile communication (GSM), long term evolution (LTE), 3G, 4G, 5G, etc. The short-range wireless network can also be any of various types, such as Bluetooth, Bluetooth Low Energy (BLE), near field communication (NFC) etc.

The user device 300 may be a computer, laptop, handheld computer, mobile communication device, smartphone, tablet, IoT device, a hardware token, a software token, or any other device capable of sending and/or receiving over the network. For example, the wireless transceiver 170 of the electronic lock 100 is capable of receiving data via short-range wireless communication protocols such as Bluetooth or Bluetooth Low Energy. The electronic lock 100 may remain connected to the user device 300 via Bluetooth and send events to the access management application 200 via the network using the user device 300 as a conduit, as well as all other events whilst it is connected to the user device 300.

The access management application 200 may be a mobile application or web application for configuration, provisioning and deprovisioning of multiple authorized users for the electronic lock. For example, an authorized user may be configured to input a predetermined password and/or a fingerprint biometric data that is configured to be stored in a password and fingerprint database for authentication purposes.

In some embodiments, the access management application 200 can be accessed via the user device 300 of the administrator, access right owner or access right grantees with the appropriate permission levels. The application 200 allows the user device to control the electronic lock 100 via short range wireless communication protocols such as Bluetooth or Bluetooth Low Energy by pairing the user device 300 with the electronic lock 100. When this is done, the user can edit or delete passwords and/or fingerprint biometric data, create customised unique passwords and/or input new fingerprint biometric data, or synchronize the data within the user device 300 to the electronic lock 100. In some embodiments, the predetermined passwords and fingerprint matching data acquired from predetermined users are stored in a password and fingerprint database 210 stored in the memory of the user device 300 or a remote server (not shown) in wireless communication with the user device 300. In some embodiments, the predetermined passwords and fingerprint matching data acquired from predetermined users stored in the password and fingerprint database 210 may be transmitted to the electronic lock 100 via the wireless transceiver 170 and stored in the password database 150 and fingerprint database 160.

The electronic lock 100 includes a lock controller 130. For example, the lock controller 130 maintains an activity log of all entries and exit of users and transfers the information to the access management application 200 via wireless communication facilitated by the wireless transceiver 170. Whenever a user accesses an entry point via the electronic lock 100, the lock controller 130 logs the unlocking and locking of the electronic locks as events. These events are saved on the memory of the electronic lock 100 and are sent via the network to the access management application 200 through the user device 300. In some embodiments, unsuccessful attempts at entry or an unauthorized entry can be logged and transmitted to the access right owner or administrators for them to be notified via the user device 300 immediately.

As used herein, the term ‘controller’ broadly refers to and is not limited to single or multi-core general purpose processor, a special purpose processor, a conventional processor, a graphical processing unit, a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit, a system on a chip (SOC), and/or a state machine.

The electronic lock 100 includes the standard structure of conventional door locks with moving parts to lock or to unlock the physical lock. The lock controller 130 controls a mechanical motor 120 which causes the mechanical motor 120 to open or close the physical lock 110. The mechanical motor 120 can have associated gears in order to generate the torque required to move the physical lock 120. The physical lock 110 may take many form factors including padlocks, deadbolts, mortises, rim locks, latches and electro-magnetic door locks.

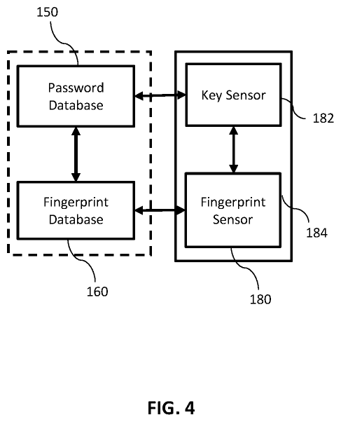

The electronic lock 100 includes a keypad 115 such as a touch screen, a virtual keypad, or physical keypad for entering an input. The keypad 115 includes one or more authentication input devices 180 in data communication with the lock controller 130 and an authentication module 190. FIG. 4 illustrates an authentication input device 180 that include a key sensor 182 and a fingerprint sensor 184. The key sensor 182 cooperates with the lock controller 130 and the authentication module 190 to receive a signal input corresponding to the alphanumeric character that the key sensor 182 is assigned to. For example, if the key sensor 182 is assigned a number ‘2’, a user that depresses the key sensor 182 will transmit a signal corresponding to number ‘2’ that is received by the lock controller 130. In other words, each of the alphanumeric characters on the keypad 115 can be an authentication input device 180. A user that would like to unlock the electronic lock 100 would contact or press on the relevant authentication input devices 180 with a finger in sequential order that would correspond to the password or PIN, which would then be received by the lock controller 130 for matching with the password or PIN stored in the password database 150.

The authentication input device 180 also includes the fingerprint sensor 184 that is configured to sense a user's finger. The fingerprint sensor 184 is in data communication with the key sensor 184 so that when a user contacts or presses on the key sensor 182 with the user's finger, not only will the key sensor 182 transmit a signal corresponding to the number assigned to key sensor 182, finger biometric data from the user's finger is also acquired, for example, for fingerprint matching or for fingerprint enrollment to be stored and later used for fingerprint matching. The fingerprint biometric data is stored in a fingerprint database 160 for matching with the acquired finger biometric data from the fingerprint sensor 184. The finger biometric data may include fingerprint minutiae data, ridge and/or valley fingerprint image data, ridge flow data, finger pore data, etc. In this way, a user that is keying in a password or Personal Identifier Number (PIN) such as a secret number into each key sensor 182 will at the same time have the fingerprint sensor 184 acquire fingerprint data from the user's finger as the user is keying in the numerical sequence of the password. In other words, with a single act of pressing the numerical sequence of the password received by each of the key sensors 182, the fingerprint sensors 184 also acquire fingerprint data from the user's finger. Both the acquired numerical sequence denoting the password and the fingerprint data are then matched with a corresponding predetermined password in the password database 150 and fingerprint matching data stored in the fingerprint database 160.

The lock controller 130 cooperates with the authentication module 190 to authenticate the user based upon an authentication request received by the plurality of authentication input devices 180. When the user is in proximity of the electronic lock 100, the user may activate the electronic lock 100 through contact with the keypad. This may cause the individual authentication input devices 180 to illuminate to indicate that it is ready to receive an authentication request. The user may then proceed to key in the password on the relevant key sensors of the authentication input devices, which includes a numerical sequence that is matched with a password of the user stored in the password database 150. At the same time, the fingerprint sensor 184 of each of the authentication input devices 180 acquires fingerprint biometric data from the user's finger as the user is keying in the password received by the key sensors. The authentication module 190 authenticates the user based on the acquired password entered with the predetermined password corresponding to the user that is stored in the password database 150, and the acquired fingerprint biometric data with the fingerprint matching data stored in the fingerprint database 160. If there is a match, the user is granted access to the entry point, and the lock controller is activated to release the physical lock to allow access to the user. If there is no match, the user is denied access to the entry point, and the user may re-enter the password on the keypad again.

As will be appreciated by those skilled in the art, there may be various matching techniques available for configuration by the user. In some embodiments, the lock controller 130 may be programmed such that the lock controller 130 will successfully authenticate the password and the fingerprint data as long as the password matches the predetermined password in the password database 150 and at least one of the fingerprint data received from one of the fingerprint sensors 184 matches the predetermined fingerprint data in the fingerprint database. This is based on the assumption that a user usually keys in each number of the password on the authentication input device using one or more fingers. For example, if a user keys in the password using the index finger and/or the middle finger, as long as the authentication input device 180 acquires a match of the fingerprint data of the index finger or the middle finger with the fingerprint database 160 on any one of the authentication input devices 180 that corresponds to the number assigned to the key sensor 182, the lock controller 130 will successfully authenticate the password and fingerprint data. In some embodiments, the lock controller 130 may be programmed such that each authentication input device 180 must have a password and fingerprint data match in order to be successfully authenticated by the lock controller 130. As will be appreciated by those skilled in the art, the authentication input devices 180 may be programmed by the access management application 200 according to the preferences of the user as to the number of authentication input devices that must have fingerprint data match with the fingerprint database in order to be successfully authenticated. For example, if the user configures a successful authentication by the lock controller 130 to have at least two fingerprint data matches, this means that at least two authentication input devices 180 must acquire fingerprint data matches in order to be successfully authenticated.

On initial setup of the electronic lock 100, the lock controller 130 may prompt the user, via the access management application 200, to acquire the finger biometric data of a finger. In some embodiments, the lock controller 130 may acquire finger biometric data based upon input from the user based upon a prompt, for example, if the user wishes to enroll finger biometric data of another finger. As will be appreciated by those skilled in the art, the lock controller 130 may perform various enrollment and matching techniques. If for example, the user does not wish to acquire finger biometric data based upon the prompt, operations of the electronic lock 100 may continue without acquiring any finger biometric data. The lock controller 130 acquires finger biometric data of at least one finger of the user until a threshold amount of finger biometric data has been acquired and stored in the fingerprint database 160. For example, the threshold amount of finger biometric data may correspond to a desired amount of finger biometric data required for authentication. The threshold amount of finger biometric data may be higher where increased placement flexibility, and/or increased security is desired. After the acquisition of the finger biometric data, the lock controller 130 may prompt the user to accept the finger biometric data. For example, the lock controller 130 may indicate to the user, via the access management application 200, that the acquisition of the finger biometric data has been completed. In some embodiments, the lock controller 130 may prompt the user to accept the finger biometric data for each finger when more than one of the user's fingers are being enrolled. Once accepted, the lock controller 130 acquires finger biometric data of the user's fingers from the finger sensor of the authentication input device that matches with the finger biometric data stored in the fingerprint database 160.

The lock controller 100 is in data communication with a fingerprint database 160 capable of storing fingerprint data. The lock controller 100 also includes a password database 150 configured to store passwords associated with the roles and permission levels of access right owners and access right grantees. The password database 150 and fingerprint database 160 can be a memory that includes a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magneto resistive Random Access Memory) or a PCRAM (Phase Change Random Access Memory). In some embodiments, the password database 150 and the fingerprint database 160 may be stored in a password and fingerprint database 210 in the user device 300 or a remote server in wireless communication with the user device 300.

The electronic lock 100 includes a power source 140 that provides power supply to the electronic lock 100. The power source 140 can be a battery energy source, for example, a rechargeable battery.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An electronic lock comprising:
a housing,
a keypad carried by the housing,
a plurality of authentication input devices on the keypad configured for sensing a user's finger, each of the plurality of authentication input devices including a key sensor associated with an alphanumeric character and a finger sensor configured to acquire fingerprint biometric data of at least one or more fingers of the user;
an authentication module configured to authenticate a user based on a password entered into the key sensors, the password comprising a sequence of alphanumeric characters acquired by the key sensors that matches with a predetermined password stored in a password database, and the fingerprint biometric data acquired by the finger sensors that matches a predetermined fingerprint matching data stored in a fingerprint database,
wherein, by a single act of pressing the plurality of authentication input devices by the user, the authentication modules authenticates the password and the fingerprint biometric data for activating release of the electronic lock to an open position for access by the user in response to the password matching the predetermined password and the fingerprint biometric data acquired by at least one or more of the finger sensors matching the predetermined fingerprint matching data, wherein the fingerprint matching data includes fingerprint biometric data of at least one or more fingerprints obtained from the user.

2. The electronic lock according to claim 1, wherein each alphanumeric character of the password is configurable to the fingerprint biometric data of the at least one or more fingers of the user.

3. The electronic lock according to claim 1, wherein the fingerprint matching data includes fingerprint biometric data of a plurality of fingers obtained from the user.

4. The electronic lock according to claim 1, wherein each of the plurality of authentication input devices is configured for display on the keypad and associated with an alphanumeric character representing a different number or character.

5. The electronic lock according to claim 1, wherein each of the plurality of authentication input devices on the keypad is a graphical button represented on a capacitive touchscreen.

6. The electronic lock according to claim 1, wherein each of the plurality of authentication input devices on the keypad is a pushbutton.

7. The electronic lock according to claim 1, further comprising a wireless transceiver in wireless communication with a user device in communication with an access management application to synchronize the predetermined passwords stored in the password database and the fingerprint matching data stored in the fingerprint database to a password and fingerprint database stored on a remote server in wireless communication with the access management application.

8. The electronic lock according to claim 1, further comprising a wireless transceiver in wireless communication with a user device in communication with an access management application for configuration of the predetermined password and acquisition of fingerprint matching data.

9. The electronic lock according to claim 1, wherein the keypad is a touchscreen.

10. The electronic lock according to claim 1, wherein the keypad is a physical keypad.

11. The electronic lock according to claim 1, wherein each of the key sensors corresponding to each of the plurality of authentication input devices receives a signal input associated with the alphanumeric character that the key sensor is assigned to in response to sensing the user's finger.

12. A method for controlling access to an entry point secured by an electronic lock controlled by a lock controller having a memory, the method comprising the steps of:
acquiring a sequence of alphanumeric characters defining a password from a plurality of authentication input devices on a keypad, wherein each of the plurality of authentication input devices includes a key sensor configured to sense the user's finger;
acquiring fingerprint biometric data of at least one or more fingers of the user from the plurality of authentication input devices at the same time the sequence of alphanumeric characters defining the password is acquired, wherein each of the plurality of authentication input devices includes a fingerprint sensor configured to acquire fingerprint biometric data;
authenticating the user, by an authentication module cooperating, with the lock controller, based upon a first match between the password and a predetermined password stored in a password database, and a second match between the acquired fingerprint biometric data and a fingerprint matching data stored in a fingerprint database, wherein the fingerprint matching data includes fingerprint biometric data of at least one or more fingers obtained from the user; and
releasing, by the lock controller, of the electronic lock into an open position for granting access to the entry point to the user, in response to a successful authentication of the first match and the second match, wherein the second match is defined by the fingerprint biometric data acquired by at least one or more of the fingerprint sensors matching the fingerprint matching data stored in the fingerprint database.

13. The method according to claim 12, wherein each alphanumeric character of the password is configurable to the fingerprint biometric data of the at least one or more fingers of the user.

14. The method according to claim 12, wherein the second match is defined by the fingerprint biometric data acquired by all the fingerprint sensors matching the fingerprint matching data stored in the fingerprint database.

15. The method according to claim 12, wherein the fingerprint matching data stored in the fingerprint database includes fingerprint data of a plurality of fingers of the user obtained from the user.

16. The method according to claim 12, wherein each of the plurality of authentication input devices is configured for display on the keypad and associated with an alphanumeric character representing a different number or character.

17. The method according to claim 12, wherein each of the plurality of authentication input devices on the keypad is a graphical button represented on a capacitive touchscreen.

18. The method according to claim 12, wherein each of the plurality of authentication input devices on the keypad is a pushbutton.
